(19) United States
(12) Patent Application Publication
(10) Pub. No.: US 2023/0417630 A1
(43) Pub. Date: Dec. 28, 2023

(54) EQUIPMENT AND METHODS FOR EVALUATING THE CHARACTERISTICS OF SPATIAL MULTIPLEX OPTICAL TRANSMISSION LINES

(71) Applicant: NIPPON TELEGRAPH AND TELEPHONE CORPORATION, Chiyoda-ku (JP)

(72) Inventors: Shingo ONO, Musashino-shi, Tokyo (JP); Atsushi NAKAMURA, Musashino-shi, Tokyo (JP)

(73) Assignee: NIPPON TELEGRAPH AND TELEPHONE CORPORATION, Tokyo (JP)

(21) Appl. No.: 18/035,769

(22) PCT Filed: Nov. 10, 2020
(86) PCT No.: PCT/JP2020/041813

§ 371 Date: May 8, 2023

(51) Int. Cl. G01M 11/00

(52) U.S. Cl. CPC G01M 11/3109

(57) ABSTRACT

A backscattered light intensity measurement unit is presented that acquires a combination of backscattered light intensities of individual transmittable spatial channels of an optical fiber obtained when test light, for the respective transmittable spatial channels of the optical fiber, is incident on the optical fiber, and a transfer matrix calculation unit that calculates a transfer matrix for each section of the optical fiber in order from a side closer to an incident end of the test light, in which characteristics in a section of the optical fiber are evaluated by using the transfer matrix.

### TECHNICAL FIELD

The present disclosure relates to a technique of evaluating characteristics of a spatial multiplex optical transmission line.

### BACKGROUND ART

As a technique for expanding a signal transmission capacity per optical fiber, there is a spatial multiplex optical transmission technique using a multi-core optical fiber or a multi-mode optical fiber. In spatial multiplex optical transmission, signals are spatially multiplexed in a plurality of spatial channels (cores or modes) in one optical fiber to increase transmission capacity. However, it is known that crosstalk of signal light or an optical loss difference between spatial channels lead to deterioration in signal quality or complication of a signal restoration process. Thus, in order to ensure desired transmission performance in a spatial multiplex optical transmission line, it is desirable that evaluation of characteristics such as crosstalk and an optical loss can be measured in a distributed manner in a longitudinal direction of an optical fiber.

As a technique capable of measuring a distribution of the crosstalk or an optical loss of a spatial multiplex optical transmission line, there is a method using optical time-domain reflectometry (Non Patent Literature 1). However, since the conventional optical time-domain reflection measurement method is based on the premise that mode coupling or an optical loss is uniform in a longitudinal direction of an optical fiber, local variation of the mode coupling or the optical loss in a transmission line causes a problem of impossibility of accurate evaluation.

### CITATION LIST

### Non Patent Literature

Non Patent Literature 1: F. Liu, G. Hu, C. Song, W. Chen, C. Chen, and J. Chen, “Simultaneous measurement of mode dependent loss and mode coupling in few mode fibers by analyzing the Rayleigh backscattering amplitudes, “Applied Optics, Vol. 57, No. 30, pp. 8894-8902, 2018.

### SUMMARY OF INVENTION

### Technical Problem

The present disclosure has been made in view of the above circumstances, and an object of the present disclosure is to provide a method capable of performing distribution measurement of evaluation of characteristics for each spatial channel in a longitudinal direction in a spatial multiplex optical transmission line in which mode coupling or an optical loss changes in the longitudinal direction.

### Solution to Problem

The present disclosure solves the above problem by calculating a transfer matrix representing evaluation of characteristics, such as crosstalk and an optical loss, for each minute distance section by using a backscattered light intensity distribution waveform of a plurality of spatial channels obtained by light reflection measurement means such as an OTDR.

According to the present disclosure, characteristics such as crosstalk and optical loss can be evaluated even in a spatial multiplex optical transmission line in which mode coupling between spatial channels or an optical loss is non-uniform.

According to the present disclosure, there is provided an apparatus including:
a backscattered light intensity measurement unit that acquires a combination of backscattered light intensities of individual transmittable spatial channels of an optical fiber obtained when test light, for the individual transmittable spatial channels of the optical fiber, is incident on the optical fiber; and
a transfer matrix calculation unit that calculates a transfer matrix for each section of the optical fiber in order from a side closer to an incident end of the test light, in which
characteristics in a section of the optical fiber are evaluated by using the transfer matrix.

According to the present disclosure, there is provided a method including the following sequence of steps:
a backscattered light intensity distribution measurement step of acquiring a combination of backscattered light intensities of individual transmittable spatial channels of an optical fiber obtained when test light, for the individual transmittable spatial channels of the optical fiber, is incident on the optical fiber;
a transfer matrix calculation step of calculating a transfer matrix for each section of the optical fiber in order from a side closer to an incident end of the test light; and
an evaluation step of evaluating characteristics in a section of the optical fiber by using the transfer matrix.

### Advantageous Effects of Invention

According to the present disclosure, it is possible to obtain evaluation of characteristics such as crosstalk and an optical loss even in a spatial multiplex optical transmission line in which mode coupling between spatial channels or an optical loss is non-uniform.

### BRIEF DESCRIPTION OF DRAWINGS

FIG. 1 is a flowchart illustrating a flow of measurement in an embodiment of the present disclosure.

FIG. 2 is a block diagram illustrating an example of an apparatus configuration used in the embodiment of the present disclosure.

### DESCRIPTION OF EMBODIMENTS

Hereinafter, an embodiment of the present disclosure will be described in detail with reference to the drawings. The present disclosure is not limited to the embodiment described below. Such an embodiment is merely an example, and the present disclosure can be carried out in forms with various modifications and improvements based on the knowledge of those skilled in the art. Constituents having the same reference signs in the present specification and the drawings indicate the same constituents.

(Optical Time-Domain Reflectometry)

In optical time-domain reflectometry (hereinafter, OTDR), pulsed test light is incident on a spatial channel to obtain a backscattered light intensity distribution waveform for a spatial channel. By changing a combination of a spatial channel on which the test light is incident and a spatial channel for detecting backscattered light, M² backscattered light intensity distribution waveforms can be obtained in a fiber having the number of spatial channels M. Assuming that a mode coupling coefficient and an optical loss coefficient for each spatial channel are uniform in a fiber longitudinal direction, the backscattered light intensities p_{bs,i}(z) and p_{bs,j}(z) detected from i-th and j-th spatial channels, in a case where the test light is incident on the i-th spatial channel, are expressed by the following equations, respectively.

$$\begin{matrix}[ Math . 1 ] & \\ {p}_{bs , i} ( z ) = \frac{{p}_{0}}{2} S \frac{{v}_{g} τ}{2} {e}^{- 2 az} ( 1 + {e}^{- 4 {h}_{i , j} z} + \frac{K - {Ke}^{- 4 {h}_{i , j} z}}{2} ) & ( 1 )\end{matrix}$$

$$\begin{matrix}[ Math . 2 ] & \\ {p}_{bs , i} ( z ) = \frac{{p}_{0}}{2} S \frac{{v}_{g} τ}{2} {e}^{- 2 az} ( 1 + {e}^{- 4 {h}_{i , j} z} + \frac{K + {Ke}^{- 2 {h}_{i , j} z} + {Ke}^{- 4 {h}_{i , j} z}}{2} ) & ( 2 )\end{matrix}$$

Here, z is a distance from the test light incident end, p₀ is incident light power, a is an optical loss coefficient, v_{g} is a light group velocity, τ is a pulse width of the test light, and S and K are constants. h_{i,j} is a mode coupling coefficient between the i-th and j-th spatial channels, and is obtained from a slope of mode coupling efficiency η_{i,j}(z) obtained from the following equation with respect to the distance z.

$$\begin{matrix}[ Math . 3 ] & \\ {η}_{i , j} ( z ) = \frac{{p}_{bs , j}}{{p}_{bs , i}} ≅ 2 {h}_{i , j} z + K & ( 3 )\end{matrix}$$

The crosstalk XT_{i,j}(z) between the i-th and j-th spatial channels at the distance z is obtained from the following equation by using Equation (3).

[Math. 4]

XT_{i,j}(z)=tan h(h_{i,j}z) (4)

The optical loss coefficient α of the i-th spatial channel is obtained from the distance dependence of p_{bs,i} by assigning h_{i,j} to Equation (1).

(Outline of Present Disclosure)

The present disclosure solves the above problem by calculating a transfer matrix, representing crosstalk and an optical loss, for each minute distance section by using a backscattered light intensity distribution waveform of a plurality of spatial channels obtained by light reflection measurement means such as OTDR. The transfer matrix T(zₖ₋₁, zₖ) in the distance section zₖ₋₁≤z<zₖ (where k is a natural number) is obtained from the simultaneous equation of the following equation. Here, z₀ is in the vicinity of the test light incident end, and it is assumed that mode coupling and an optical loss at 0≤z<z₀ are negligible.

[Math. 5]

Pₒᵤₜ(zₖ)=T(z₀,z₁) . . . T(zₖ₋₂,zₖ₋₁)Pₒᵤₜ(z₀)T(zₖ₋₁,zₖ)T(zₖ₋₂,zₖ₋₁) . . . T(z₀,z₁) (5)

Here, Pₒᵤₜ(zₖ) is a matrix of the backscattered light intensity obtained with respect to the distance zₖ point, and the (i,j) component (where i and j are natural numbers.) of the matrix Pₒᵤₜ(zₖ) represents the backscattered light intensity detected from the i-th spatial channel when the test light is incident on the j-th spatial channel. The (i,i) component of the matrix T(zₖ₋₁, zₖ) represents the optical loss of the i-th spatial channel in the section zₖ₋₁≤z<zₖ, and the (i,j) component (where i≠j) represents the mode coupling between the i-th spatial channel and the j-th spatial channel. T(z₀, z₁) . . . T(zₖ₋₂, zₖ₋₁) T(zₖ₋₁, zₖ) and T(zₖ₋₁, zₖ) T(zₖ₋₂, zₖ₋₁) . . . T(z₀, z₁) multiplied from the left and right of Pₒᵤₜ(z₀) on the right side, respectively, are products of k matrices each. That is, in the case of k=1 and k=2, Equation (5) is as follows.

(In case of k=1)

[Math. 6]

Pₒᵤₜ(z₁)=T(z₀,z₁)Pₒᵤₜ(z₀)T(z₀,z₁) (6)

[Math. 7]

Pₒᵤₜ(z₂)=T(z₀,z₁)T(z₁,z₂)Pₒᵤₜ(z₀)T(z₁,z₂)T(z₀,z₁) (7)

T(z₀, z₁) satisfying Equation (6) is first obtained, T(z₀, z₁) is then assigned to Equation (7) to obtain T(z₁, z₂), and thereafter, T(z₂, z₃), T(z₃, z₄), . . . are sequentially obtained from Equation (5) for each case of k=3, 4, . . . , and thus T(zₖ₋₁, zₖ) can be obtained for any k. By using T(zₖ₋₁, zₖ), the transfer matrix T(zₐ, z_{b}) in a section zₐ≤z<z_{b} (where a and b are non-negative integers) is obtained from the following equation.

[Math. 8]

T(zₐ,z_{b})=T(z_{b-1},z_{b})T(z_{b-2},z_{b-1}) . . . T(zₐ₊₁,zₐ₊₂)T(zₐ,zₐ₊₁) (8)

The crosstalk XT_{i,j}(zₐ, z_{b}) from the j-th spatial channel to the i-th spatial channel in the section zₐ≤z<z_{b} is obtained from the following equation by using the (i, j) component η_{i,j}(zₐ, z_{b}) that is a non-diagonal component of T(zₐ, z_{b})

$$\begin{matrix}[ Math . 9 ] & \\ {XT}_{i , j} ( {z}_{a} , {z}_{b} ) = - 10 log \frac{{η}_{i , j} ( {z}_{a} , {z}_{b} )}{{η}_{i , i} ( {z}_{a} , {z}_{b} )} [ dB ] & ( 9 )\end{matrix}$$

The average crosstalk XTᵢ(zₐ, z_{b}) to the i-th spatial channel in the same distance section is obtained from the following equation.

$$\begin{matrix}[ Math . 10 ] & \\ {XT}_{i} ( {z}_{a} , {z}_{b} ) = - 10 log \frac{{\sum }_{j \neq i} {η}_{i , j} ( {z}_{a} , {z}_{b} )}{{η}_{i , i} ( {z}_{a} , {z}_{b} )} [ dB ] & ( 10 )\end{matrix}$$

The optical loss Lᵢ(zₐ, z_{b}) of the i-th spatial channel in the same distance section is obtained from the following equation by using the diagonal component of T(zₐ, z_{b}).

[Math. 11]

Lᵢ(zₐ,z_{b})=−10 log η_{i,i}(zₐ,z_{b})[dB] (11)

From the above description, the matrix T(zₐ, z_{b}) is obtained by using Equations (5) to (8), and the (i,j) component η_{i,j}(zₐ, z_{b}) of T(zₐ, z_{b}) is assigned to Equations (9) to (11), and thus the crosstalk and the optical loss in a section zₐ≤z<z_{b} are obtained. The matrix calculation in the present disclosure is calculation for power (non-negative real number) instead of field (complex number), and elements of each matrix in the present disclosure are non-negative real numbers.

An embodiment of the present disclosure will be described with reference to the accompanying drawings. Here, as an example, a case where OTDR is used as light reflection measurement means and a two-mode single-core optical fiber is used as a measurement target optical fiber will be described. The present disclosure is not limited thereto, and other means such as optical frequency-domain reflectometry may be used as light reflection measurement means, and a multimode optical fiber or a multicore optical fiber may be used as a measurement target optical fiber. When a multicore optical fiber is used as a measurement target optical fiber, the following mode selection means may be replaced with a fan-in/fan-out device or the like.

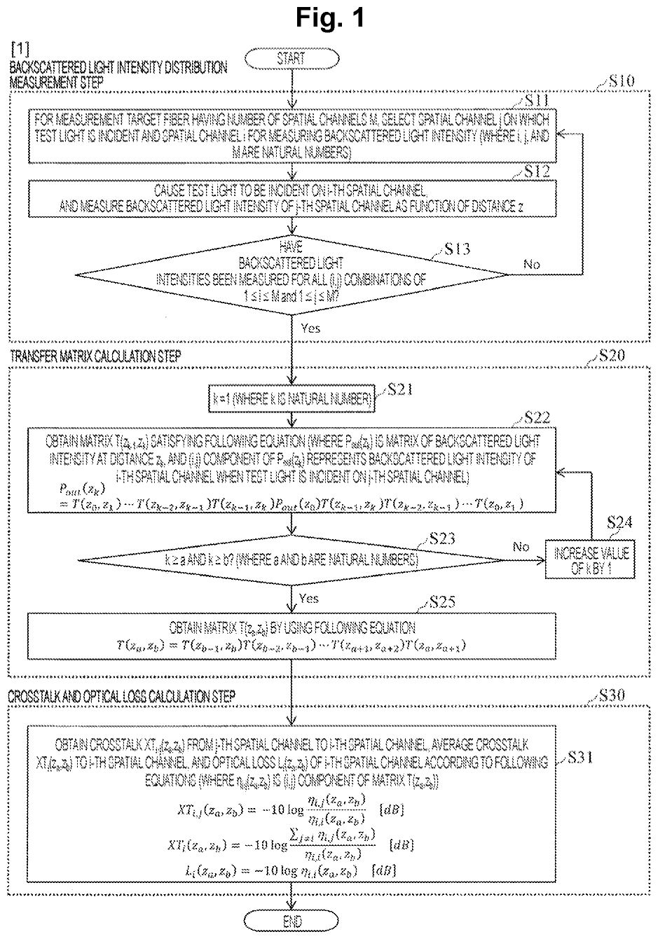

FIG. 1 is a flowchart illustrating an example of an embodiment of a characteristic evaluation method according to the present disclosure. The characteristic evaluation method according to the present disclosure sequentially includes a backscattered light intensity distribution measurement step S10, a transfer matrix calculation step S20, and a crosstalk and optical loss calculation step S30. In the present embodiment, first, in the backscattered light intensity distribution measurement step S10, a backscattered light intensity distribution waveform in a certain propagation mode is obtained by using the light reflection measurement means.

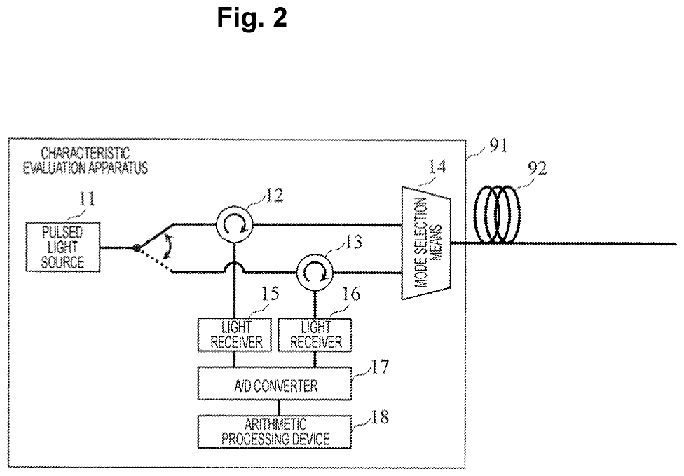

FIG. 2 is an example of an apparatus configuration used in the present embodiment. A characteristic evaluation apparatus 91 of the present embodiment includes a pulsed light source 11, circulators 12 and 13, mode selection means 14, light receivers 15 and 16, an A/D converter 17, and an arithmetic processing device 18. These configurations function as a backscattered light intensity measurement unit. The arithmetic processing device 18 functions as a transfer matrix calculation unit, a crosstalk calculation unit, and an optical loss calculation unit. In the configuration in FIG. 2, except for a measurement target optical fiber 92, optical fibers are single-mode single-core optical fibers.

The pulsed light source 11 is used as a light source, and pulsed test light is incident on the measurement target optical fiber 92 in a propagation mode by the mode selection means 14. The light receivers 15 and 16 are connected to ports corresponding to the respective propagation modes of the mode selection means, and the backscattered light intensities in the plurality of propagation modes are individually converted into electrical signals by the light receivers. In this case, backscattered light received after the time t has elapsed from incidence of the test light corresponds to backscattered light from a distance z=ct/2 (where c is the group velocity of light in the measurement target optical fiber 92) from the incident end. The backscattered light intensity signal converted into the electrical signal is converted into a digital signal by the A/D converter 17 and transferred to the arithmetic processing device 18.

(Backscattered Light Intensity Distribution Measurement Step S10)

For the measurement target optical fiber 92 having the number of spatial channels M, the characteristic evaluation apparatus 91 selects a spatial channel j to which the test light is incident and a spatial channel i for measuring a backscattered light intensity (step S11). Here, i, j, and M are natural numbers.

Next, the characteristic evaluation apparatus 91 makes the test light to be incident on an i-th spatial channel, and measures the backscattered light intensity of a j-th spatial channel as a function of the distance z (S12).

The characteristic evaluation apparatus 91 determines whether backscattered light intensities have been measured for all (i,j) combinations of 1≤i≤M and 1≤j≤M (S13) and repeatedly performs steps S11 and S12 until the backscattered light intensities for all (i,j) combinations are measured.

Consequently, the characteristic evaluation apparatus 91 acquires a combination of backscattered light intensities of individual transmittable spatial channels of the measurement target optical fiber 92 obtained when pieces of test light, for the individual transmittable spatial channels of the measurement target optical fiber 92, are incident on the measurement target optical fiber 92.

As described above, in the present embodiment, a combination of a propagation mode of the test light and a propagation mode of the backscattered light is changed. In a case where a two-mode single-core optical fiber is used as the measurement target optical fiber 92, a total of four types of backscattered light intensity distribution waveforms including two modes of test light and two modes of backscattered light are obtained. Consequently, the backscattered light intensity of the i-th spatial channel obtained by making the test light incident on the j-th spatial channel can be detected. In the present embodiment, an example in which a two-mode single-core optical fiber is used as the measurement target optical fiber 92 is described, but M² backscattered light intensity distribution waveforms are obtained in a case where the number of spatial channels of the measurement target optical fiber 92 is M.

(Transfer Matrix Calculation Step S20)

Next, in the transfer matrix calculation step S20 illustrated in FIG. 1, the arithmetic processing device 18 obtains a transfer matrix distribution in the longitudinal direction of the measurement target optical fiber 92 by using the backscattered light intensity distribution waveform measured in the backscattered light intensity distribution measurement step S10.

In this step, first, the transfer matrix T(z₀, z₁) in the section z₀≤z<z₁ is obtained. Here, z₀ is in the vicinity of the test light incident end, and it is assumed that mode coupling and an optical loss at 0≤z<z₀ are negligible. A matrix Pₒᵤₜ(z₀) of the backscattered light intensity observed with respect to z=z₀ is expressed as the following equation.

[Math. 12]

Pₒᵤₜ(z₀)=BPᵢₙ (12)

Here, the matrix B is a matrix representing a capture rate in each propagation mode in the backscattering process, and each component of Pₒᵤₜ(z₀) and B is defined as follows.

$$\begin{matrix}[ Math . 13 ] & \\ {P}_{out} ( {z}_{0} ) ≡ ( \begin{matrix}{p}_{1 , 1} ( {z}_{0} ) & {p}_{1 , 2} ( {z}_{0} ) \\ {p}_{2 , 1} ( {z}_{0} ) & {p}_{2 , 2} ( {z}_{0} )\end{matrix} ) & ( 13 )\end{matrix}$$

$$\begin{matrix}[ Math . 14 ] & \\ B ≡ ( \begin{matrix}{b}_{1 , 1} & {b}_{1 , 2} \\ {b}_{2 , 1} & {b}_{2 , 2}\end{matrix} ) & ( 14 )\end{matrix}$$

Here, p_{i,j}(z₀) is a backscattered light intensity in the mode i observed with respect to z=z₀ in a case where the test light is incident in the mode j, and b_{i,j} is a ratio of the intensity at which propagation light in the mode j is backscattered in the mode i. When normalization is performed such that Pin becomes an identity matrix, Equation (12) is expressed as the following equation.

[Math. 15]

Pₒᵤₜ(z₀)=B (15)

On the other hand, a matrix Pₒᵤₜ(z₁) of the backscattered light intensity observed with respect to z=z₁ is expressed as the following equation.

[Math. 16]

Pₒᵤₜ(z₁)=T(z₀,z₁)BT(z₀,z₁) (16)

Equation (15) is assigned to Equation (16), and the relationship of Equation (6) is obtained with respect to Pₒᵤₜ (z₀) and Pₒᵤₜ(z₁). T(z₀, z₁) is obtained by solving Equation (6) as simultaneous equations having each component of T(z₀, z₁) as a variable (step S22). Next, the transfer matrix T(z₁, z₂) in the section z₁≤z<z₂ is obtained (steps S23, S24, and S22). A matrix Pₒᵤₜ(z₂) of the backscattered light intensity observed with respect to z=z₂ is expressed as the following equation.

[Math. 17]

Pₒᵤₜ(z₂)=T(z₀,z₁)T(z₁,z₃)BT(z₁,z₂)T(z₀,z₁) (17)

Equation (15) is assigned to Equation (17), and the relationship of Equation (7) is obtained with respect to Pₒᵤₜ(z₀) and Pₒᵤₜ(z₂). T(z₁, z₂) is obtained by assigning each component of T(z₀, z₁) obtained from the simultaneous equation (6) to Equation (7) and solving Equation (7) as simultaneous equations having each component of T(z₁, z₂) as a variable (step S25).

Thereafter, T(z₂, z₃), T(z₃, z₄), . . . are sequentially obtained from Equation (5) for each case of k=3, 4, . . . , Next, the transfer matrix T(zₐ, z_{b}), in the distance section zₐ≤z<z_{b} (where a and b are non-negative integers;) for obtaining crosstalk and an optical loss, is obtained by using Equation (8).

(Crosstalk and Optical Loss Calculation Step S30)

Finally, in the crosstalk and optical loss calculation step S30 illustrated in FIG. 1, the arithmetic processing device 18 assigns the (i,j) component η_{i,j}(zₐ, z_{b}) of T(zₐ, z_{b}) to the Equations (9) to (11) to obtain the crosstalk and the optical loss at zₐ≤z<z_{b} (S31).

In the present embodiment, the case where the measurement target optical fiber 92 is a two-mode fiber is described, but the present disclosure is not limited thereto, and an optical fiber having the number of spatial channels M (where M is an integer of 2 or more) may be used. The number of spatial channels M makes simultaneous equations (5) to (7) be solved with respect to M² variables, so that it becomes difficult to directly obtain a solution as the number of spatial channels increases. However, for example, a value close to the solution may be searched numerically according to the following method, and the obtained value may be used as each approximated component of T(zₖ₋₁, zₖ). Hereinafter, two types of methods for searching an approximate solution of each component of T(zₖ₋₁, zₖ) from the simultaneous equation (5) will be described. Hereinafter, for the sake of simplification, the components η_{1,1}(zₖ₋₁, zₖ), . . . , η_{i,j}(zₖ₋₁, zₖ), . . . , and η_{M,M}(zₖ₋₁, zₖ) of T(zₖ₋₁, zₖ) will be abbreviated to η_{1,1}, . . . , η_{i,j}, . . . , and η_{M,M}.

(First Approximate Solution Search Method)

A function c(η_{1,1}, . . . , η_{i,j}, . . . , η_{M,M}) is defined as the following equation.

$$\begin{matrix}[ Math . 18 ] & \\ c ( {η}_{1 , 1} , … , {η}_{i , j} , … , {η}_{M , M} ) = {\sum }_{i = 1}^{M} {\sum }_{j = 1}^{M} {[ {q}_{i , j} ( {η}_{1 , 1} , … , {η}_{i , j} , … , {η}_{M , M} ) - {p}_{i , j} ( {z}_{k} ) ]}^{2} & ( 18 )\end{matrix}$$

Here, q_{i,j}(η_{1,1}, . . . , η_{i,j}, . . . , η_{M,M}) is the (i, j) component of the right side of Equation (5), and p_{i,j}(zₖ) is the (i,j) component of the matrix Pₒᵤₜ(zₖ). Since c(η_{1,1}, . . . , η_{i,j}, . . . , η_{M,M}) is a function that takes a value of 0 or more and becomes 0 when η_{1,1}, . . . , η_{i,j}, . . . , and η_{M,M} satisfy the simultaneous equation (5), an approximate solution of the simultaneous equation (5) is obtained from a condition for minimizing c(η_{1,1}, . . . , η_{i,j}, . . . , η_{M,M}).

Regarding η_{1,1}, . . . , η_{i,j}, . . . , and η_{M,M} that minimizes c(η_{1,1}, . . . , η_{i,j}, . . . , η_{M,M}), initial values are given to η_{1,1}, . . . , η_{i,j}, . . . , η_{M,M}, and c(η_{1,1}, . . . , η_{i,j}, . . . , η_{M,M}) is repeatedly calculated by changing by minute amounts Δη_{1,1}, . . . , η_{i,j}, . . . , and Δη_{M,M}, respectively, and η_{1,1}, . . . , η_{i,j}, . . . , η_{M,M} when c(η_{1,1}, . . . , η_{i,j}, . . . , η_{M,M}) converges to a value close to 0 is taken as an approximate solution. Δη_{i,j} in this case is obtained from the following equation.

$$\begin{matrix}[ Math . 19 ] & \\ {Δη}_{i , j} = - d {\sum }_{k = 1}^{M} {\sum }_{l = 1}^{M} \frac{\partial c ( {η}_{1 , 1} , … , {η}_{i , j} , … , {η}_{M , M} )}{\partial {q}_{k , l} ( {η}_{1 , 1} , … , {η}_{i , j} , … , {η}_{M , M} )} \frac{\partial {q}_{k , l} ( {η}_{1 , 1} , … , {η}_{i , j} , … , {η}_{M , M} )}{\partial {η}_{i , j}} & ( 19 )\end{matrix}$$

Here, d is a constant. Equation (19) means that η_{i,j} is changed in the reverse direction of a gradient of c(η_{1,1}, . . . , η_{i,j}, . . . , η_{M,M}). Since the gradient of c(η_{1,1}, . . . , η_{i,j}, . . . , η_{M,M}) is 0 when c(η_{1,1}, . . . , η_{i,j}, . . . , η_{M,M}) takes the minimum value, an approximate solution of η_{1,1}, . . . , η_{i,j}, . . . , and η_{M,M} satisfying the simultaneous equation (5) can be obtained by changing η_{1,1}, . . . , η_{i,j}, . . . , and η_{M,M} by minute amounts in the reverse direction of the gradient of c(η_{1,1}, . . . , η_{i,j}, . . . , η_{M,M}).

(Second Approximate Solution Search Method)

A function f(η_{1,1}, . . . , η_{i,j}, . . . , η_{M,M}) is defined as the following equation.

$$\begin{matrix}[ Math . 20 ] & \\ f ( {η}_{1 , 1} , … , {η}_{i , j} , … , {η}_{M , M} ) = {\sum }_{i = 1}^{M} {\sum }_{j = 1}^{M} [ {q}_{i , j} ( {η}_{1 , 1} , … , {η}_{i , j} , … , {η}_{M , M} ) - {p}_{i , j} ( {z}_{k} ) ] & ( 20 )\end{matrix}$$

Since f(η_{1,1}, . . . , η_{i,j}, . . . , η_{M,M}) is 0 when η_{1,1}, . . . , η_{i,j}, . . . , and η_{M,M} satisfy the simultaneous equation (5), an approximate solution of the simultaneous equation (5) is obtained from a condition that f(η_{1,1}, . . . , η_{i,j}, . . . , η_{M,M}) takes a value close to 0.

Regarding η_{1,1}, . . . , η_{i,j}, . . . , η_{M,M} satisfying f(η_{1,1}, . . . , η_{i,j}, . . . , η_{M,M})=0, initial values are given to η_{1,1}, . . . , η_{i,j}, . . . , η_{M,M}, and f(η_{1,1}, . . . , η_{i,j}, . . . , η_{M,M}) is repeatedly calculated by changing by minute amounts Δη_{1,1}, . . . , Δη_{i,j}, . . . , and Δη_{M,M}, respectively, and η_{1,1}, . . . , η_{i,j}, . . . , and η_{M,M} when f(η_{1,1}, . . . , η_{i,j}, . . . , η_{M,M}) converges to a value close to 0 is taken as an approximate solution. Δη_{i,j} in this case is obtained from the following equation.

$$\begin{matrix}[ Math . 21 ] & \\ {Δη}_{i , j} = - \frac{f ( {η}_{1 , 1} , … , {η}_{i , j} , … , {η}_{M , M} )}{{\sum }_{k = 1}^{M} {\sum }_{l = 1}^{M} \frac{\partial f ( {η}_{1 , 1} , … , {η}_{i , j} , … , {η}_{M , M} )}{\partial {q}_{k , l} ( {η}_{1 , 1} , … , {η}_{i , j} , … , {η}_{M , M} )} \frac{\partial {q}_{k , l} ( {η}_{1 , 1} , … , {η}_{i , j} , … , {η}_{M , M} )}{\partial {η}_{i , j}}} & ( 21 )\end{matrix}$$

Equation (21) means that η_{i,j} is changed toward the η_{i,j} coordinate at the intersection of the tangent of f(η_{1,1}, . . . , η_{i,j}, . . . , η_{M,M}) and the η_{i,j} axis. In this case, since f(η_{1,1}+Δη_{1,1}, . . . , η_{i,j}+Δη_{i,j}, . . . , η_{M,M}+Δη_{M,M}) takes a value closer to 0 than f(η_{1,1}, . . . , η_{i,j}, . . . , η_{M,M}), by changing η_{1,1}, . . . , η_{i,j}, . . . , and η_{M,M} by minute amounts Δη_{1,1}, . . . , Δη_{i,j}, . . . , Δη_{M,M} until making f(η_{1,1}+Δη_{1,1}, . . . , η_{i,j}+Δη_{i,j}, . . . , η_{M,M}+Δη_{M,M}) converge to a value close to 0, an approximate solution of η_{1,1}, . . . , η_{i,j}, . . . , and η_{M,M} satisfying the simultaneous equation (5) can be obtained.

### Effects of Present Disclosure

According to the present disclosure, it is possible to obtain evaluation of characteristics such as crosstalk and an optical loss even in a spatial multiplex optical transmission line in which mode coupling between spatial channels or an optical loss is non-uniform. In particular, since there are a large number of connection points and fiber bending depending on a laying environment in an actual transmission line, it is assumed that the characteristics change locally and temporally with transmission line laying work or maintenance operation work. In the related art, it is difficult to accurately evaluate characteristics since a backscattered light intensity fluctuates after a point where mode coupling locally changes due to a connection point or bending of an optical fiber, but in the present disclosure, evaluation of characteristics such as crosstalk and an optical loss including the influence of a connection point or fiber bending can be measured in a distributed manner, and thus there is an advantage over the related art from the viewpoint of usefulness in an actual transmission line environment.

### INDUSTRIAL APPLICABILITY

The present disclosure can be applied to information and communication industries.

### REFERENCE SIGNS LIST

11 PULSED LIGHT SOURCE
12, 13 CIRCULATOR
14 MODE SELECTION MEANS
15, 16 LIGHT RECEIVER
17 A/D CONVERTER
18 ARITHMETIC PROCESSING DEVICE
91 CHARACTERISTIC EVALUATION APPARATUS
92 MEASUREMENT TARGET OPTICAL FIBER

1. An apparatus comprising:
a backscattered light intensity measurement unit that acquires a combination of backscattered light intensities of individual transmittable spatial channels of an optical fiber obtained when test light, for the individual transmittable spatial channels of the optical fiber, is incident on the optical fiber; and
a transfer matrix calculation unit that calculates a transfer matrix for each section of the optical fiber in order from a side closer to an incident end of the test light, wherein
characteristics in a section of the optical fiber are evaluated by using the transfer matrix.

2. The apparatus according to claim 1, wherein
the backscattered light intensity measurement unit measures, as a function Pₒᵤₜ(z) of a distance z, a matrix of a backscattered light intensity obtained using light incident on a j-th spatial channel, for transmission through the optical fiber by using spatial multiplexing, and detected from an i-th spatial channel, as an (i,j) component, and
the transfer matrix calculation unit
obtains T(zₖ₋₁, zₖ) (where k is a natural number) satisfying Equation (C1) for each case of k=1 to b by using the Pₒᵤₜ(z), and
calculates a transfer matrix T(zₐ, z_{b}) in a section zₐ≤z<z_{b} (where a and b are non-negative integers) by using Equation (C2).
[Math. C1]
Pₒᵤₜ(zₖ)=T(z₀,z₁) . . . T(zₖ₋₂,zₖ₋₁)T(zₖ₋₁,zₖ)Pₒᵤₜ(z₀)T(zₖ₋₁,zₖ)T(zₖ₋₂,zₖ₋₁) . . . T(z₀,z₁) (C1)
[Math. C2]
T(zₐ,z_{b})=T(z_{b-1},z_{b})T(z_{b-2},z_{b-1}) . . . T(zₐ₊₁,zₐ₊₂)T(zₐ,zₐ₊₁) (C2)

3. The apparatus according to claim 2, wherein
the transfer matrix calculation unit
calculates a square error of the right side with respect to the left side of Equation (C1) as a function c(η_{1,1}, . . . , η_{i,j}, . . . , η_{M,M}) having matrix components η_{1,1}, . . . , η_{i,j}, . . . , and η_{M,M} (where η_{i,j} is the (i,j) component of T(zₖ₋₁, zₖ)) of T(zₖ₋₁, zₖ) as variables, and
gives initial values to η_{1,1}, . . . , η_{i,j}, . . . , and η_{M,M} changes values of η_{1,1}, . . . , η_{i,j}, . . . , and η_{M,M} in a reverse direction of a gradient of c(η_{1,1}, . . . , η_{i,j}, . . . , η_{M,M}), and calculates the T(zₐ, z_{b}) by using η_{1,1}, . . . , η_{i,j}, . . . , and η_{M,M} when a value of c(η_{1,1}, . . . , η_{i,j}, . . . , η_{M,M} converges.

4. The apparatus according to claim 2, wherein
the transfer matrix calculation unit
calculates a difference between the left side and the right side of Equation (C1) as a function f(η_{1,1}, . . . , η_{i,j}, . . . , η_{M,M}) having matrix components η_{1,1}, . . . , η_{i,j}, . . . , and η_{M,M} (where η_{i,j} is the (i,j) component of T(zₖ₋₁, zₖ)) of T(zₖ₋₁, zₖ) as variables,
gives initial values to η_{1,1}, . . . , η_{i,j}, . . . , and η_{M,M}, changes values of η_{1,1}, . . . , η_{i,j}, . . . , and η_{M,M} to approach an η_{1,1} coordinate . . . , an η_{i,j} coordinate, . . . , and an η_{M,M} coordinate of intersections of a tangent of f(η_{1,1}, . . . , η_{i,j}, . . . , η_{M,M}) and an η_{1,1} axis, β, an η_{i,j} axis . . . , and an η_{M,M} axis, respectively, and
calculates the T(zₐ, z_{b}) by using η_{1,1}, . . . , η_{i,j}, . . . , and η_{M,M} when a value of f(η_{1,1}, . . . , η_{i,j}, . . . , η_{M,M}) converges.

5. The apparatus according to claim 2, further comprising:
a crosstalk calculation unit that calculates crosstalk in the section zₐ≤z<z_{b} by using a non-diagonal component of the T(zₐ, z_{b}).

6. The apparatus according to claim 2, further comprising:
an optical loss calculation unit that calculates an optical loss in the section zₐ≤z<z_{b} by using a diagonal component of the T(zₐ, z_{b}).

7. A method comprising the following sequence of steps:
a backscattered light intensity distribution measurement step of acquiring a combination of backscattered light intensities of individual transmittable spatial channels of an optical fiber obtained when test light, for the individual transmittable spatial channels of the optical fiber, is incident on the optical fiber;
a transfer matrix calculation step of calculating a transfer matrix for each section of the optical fiber in order from a side closer to an incident end of the test light; and
an evaluation step of evaluating characteristics in a section of the optical fiber by using the transfer matrix.
